(19) United States
(12) Patent Application Publication
(10) Pub. No.: US 2014/0171133 A1
(43) Pub. Date: Jun. 19, 2014

(54) QUERY RESPONSE

(71) Applicant: Google Inc., (US)

(72) Inventors: Matthew Nicholas Stuttle, Sussex (GB); Robert William Hamilton, San Francisco, CA (US)

(73) Assignee: Google Inc., Mountain View, CA (US)

(21) Appl. No.: 13/717,888

(22) Filed: Dec. 18, 2012

(51) Int. Cl. H04W 4/14

(52) U.S. Cl. CPC H04W 4/14
USPC 455/466

(57) ABSTRACT

In accordance with an example embodiment of the disclosure, a non-transitory, machine-readable storage medium may have stored thereon a computer program having at least one code section. The at least one code section may be executable by a first electronic processing device for causing the first electronic processing device to execute context pertinent responses based on at least one status query electronically communicated to the first electronic processing device from a second electronic processing device. The at least one code section may control the first device to perform examining the query to determine a pertinent context. A query processing device may be queried via the first device. Responsive to the querying, context pertinent information may be received based on at least one database of stored context pertinent information. A context pertinent response may be executed based on the obtained context pertinent information.

### BACKGROUND

Mobile device users receive large numbers of repeated queries for simple information via chat services or SMS (Short Message Service). Such messages may ask for a current location of a receiving user, whether the receiving user has been to a certain location, whether the receiving user has placed a specific phone call, whether the receiving user is currently at a given location, etc.

With current mobile devices, users are required to divert their attention to respond to these simple, often repeated queries. The adverse impact of such continued diversions can be compounded against a user's productivity. This unfortunate side effect is magnified when a user is handling otherwise time sensitive and critical tasks.

Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

A system and/or method is provided for automated response to personal queries, with optional machine learning to establish privacy norms, substantially as shown in and/or described in connection with at least one of the figures, as set forth more completely in the claims.

In accordance with an example embodiment of the disclosure, a non-transitory, machine-readable storage medium may have stored thereon a computer program having at least one code section. The at least one code section may be executable by a first electronic processing device for causing the first electronic processing device to execute context pertinent responses based on at least one status query electronically communicated to the first electronic processing device from a second electronic processing device. The at least one code section may control the first device to perform examining the query to determine a pertinent context. A query processing device may be queried via the first device. Responsive to the querying, context pertinent information may be received based on at least one database of stored context pertinent information. A context pertinent response may be executed based on the obtained context pertinent information.

These and other advantages, aspects and features of the present disclosure, as well as details of illustrated implementation(s) thereof, will be more fully understood from the following description and drawings.

### BRIEF DESCRIPTION OF THE DRAWINGS

FIG. 1 is a block diagram illustrating example architecture for providing context pertinent responses, in accordance with an embodiment of the disclosure.

FIG. 2 is a flow chart illustrating example steps of a method for providing context pertinent responses, in accordance with an embodiment of the disclosure.

FIG. 3 is a block diagram illustrating example architecture for providing context pertinent responses with online learning of privacy norms, in accordance with an embodiment of the disclosure.

FIG. 4 is a flow chart illustrating example steps of a method for providing context pertinent responses with online learning of privacy norms, in accordance with an embodiment of the disclosure.

FIG. 5 is a block diagram illustrating example architecture for providing query responses and learning new query-related actions from user input, in accordance with an embodiment of the disclosure.

FIG. 6 is a block diagram of an example mobile device used for providing context pertinent responses, in accordance with an example embodiment of the disclosure.

FIG. 7 is a flow chart illustrating example steps of another method for providing context pertinent responses, in accordance with an embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations.

The present disclosure relates to a method and system for automated response to personal queries, with optional machine learning to establish privacy norms. In various implementations, the disclosed embodiments relate to a first mobile or stationary device executing a “client” or “cloud”-based application that derives context pertinent responses to communications received by the first device from a second mobile or stationary device, that is, an original sender, and automatically (and essentially immediately) executing the context pertinent responses. For example, received communications may include queries, such as (but not limited to):

“Where are you?”

“Have you been to _ yet?”

“Are you busy now?”

“Do you have a meeting tonight?”

“Are you on the train yet?”

“When will you be home?”

“Have you called doctor yet?”

With such queries, a context pertinent response may include sending a context pertinent answer to the second device. Respective context pertinent answers to the above queries may include:

“In a meeting.”

“No.”

“Yes.”

“Yes.”

“No.”

“10:00 PM”

“No.”

Such information may be obtained by accessing data on the first device (or a remote server, such as a corporate email/calendar server, via the first device), including one or more of a call list, a calendar database, global positioning data, etc.

Other received query communications may include task reminders, such as “remind him he needs to call the dentist.” With such task reminders, a context pertinent response may include querying the first (mobile) device call list, both outgoing and incoming, for a time frame that is predetermined or identified in the originating query, and automatically (e.g., without user intervention) setting a calendar reminder alert for the first device user, if such a call is not listed in the user calendar.

In addition, context pertinent responses may include applying appropriate privacy levels (norms). For example, return texts, emails and calendar reminders in response to a query may be subject to a higher privacy level depending on the context, or the identity of the sender.

Periodically or optionally, so as to check the system's correctness, and/or during training periods, the system executing the “client” or “cloud”-based application may request authorizations (e.g., authorization to proceed sending a suggested response) to proposed context pertinent responses to received communications. From the authorizations, the system may track and record correct context pertinent responses, and may also execute context pertinent response to communications received thereafter from a given user. In this regard, online learning may be used to create and store a query response template based on user input, in instances when there is no previously memorized (stored) template to address a received query. Additionally, a user profile associated with the sender of a query may also be stored based on receiving user input, where the stored user profile may specify various privacy norms for responding to specific queries from the user.

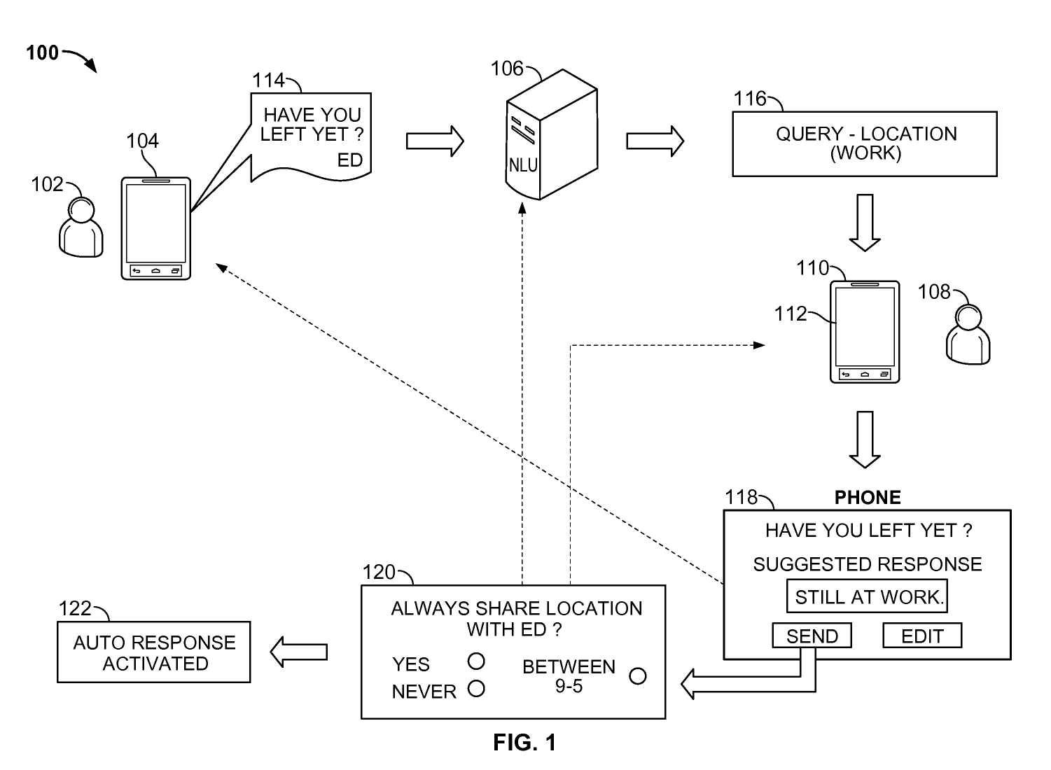

FIG. 1 is a block diagram illustrating example architecture for providing context pertinent responses, in accordance with an embodiment of the disclosure. Referring to FIG. 1, the example architecture 100 may comprise a first (receiving) device 110 with a receiving user 108, a second (sending) device 104 with a sending user 102, and a natural language understanding (NLU) module 106. The first and second devices may include personal computing devices, such as a mobile phone, a smart phone, a tablet or another personal computing device enabled to communicate in a wired and/or wireless (e.g., cellular) network. The first device 110 may execute a “client” or “cloud”-based application that derives context pertinent responses to communications received by the first device from the second device 104, and automatically (and essentially immediately) execute context pertinent responses.

The NLU 106 may comprise suitable circuitry, logic and/or code and may be operable to apply natural language understanding functionalities to queries (e.g., query 114) received from the sending user 102 via the second device 104, and generate a query interpretation 116. The query interpretation 116 may comprise an indication of the type of query characterizing query 114. Natural language processing functionalities of the NLU module 106 may be based on handwritten rules/grammars or may be learned from training corpora or users' behavior over time (i.e., the responses that are given to frequent queries). Additionally, standard/common responses may be learned from user behavior in relation to received queries, or adapted/selected from a canonical set stored in the cloud.

Referring to FIG. 1, in operation, a query 114 (“Have you left yet? Ed”) may be sent by user 102 via the second device 104 to the first device 110 of user 108. In response to the query 114, the NLU 106 may interpret the query 114 and generate a query interpretation 116 of the received query type (e.g., a Query_Location type based on the current query 114). The first device 110 (e.g., via the application executed by the first device 110 and by accessing GPS data of the device 110 and/or calendar schedule of user 108) may then determine that the user 108 is at work and a context appropriate response may be sending a context pertinent response (e.g., text or email) answer back to the originating sender, user 102. The first device 110 may propose for authorization by user 108 the following context responsive answer via the template 118 displayed on screen 112 of the device 110:

“Still at work.”

However, instead of one possible answer, the first device 110 may present a palette/list of possible canned or previously learned responses (templates) for authorization by the user 108. To obtain authorization, the first device 110 may provides the following authorization query to user 108 as part of the template 118:

“OK TO SEND: no/yes? EDIT Response: no/yes?”

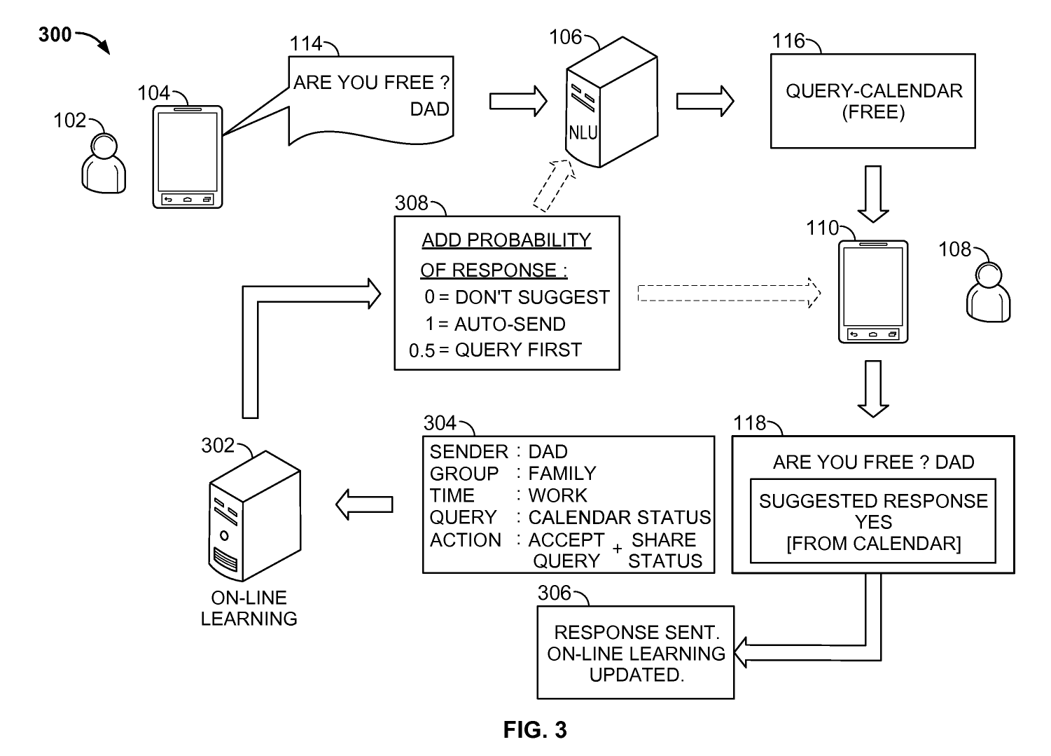

Based on the response by user 108, such as “OK TO SEND—yes”, the first device 110 may respond as proposed and may communicate the response to the second device 104. The user 108 may then be presented with template 120 where privacy settings for communications with the sending user (“Ed”) may be selected (e.g., when, if it all, is it ok to share location with the particular user). After the privacy norms for communication with user “Ed” are established, an auto-response feature 122 may be activated for this user. The established privacy norms for user “Ed” may be stored by the first device 110, the NLU 106 and/or by an online learning module (illustrated in FIG. 3) for subsequent consideration and use when the same (or different) query is received from user “Ed”. In this regard, the first device 110 and/or additional modules within the architecture 100 (e.g., NLU 106 and/or an on-line learning module) may be operable to learn (or store) standard/common responses from user behavior as well as profiles with privacy norms specifying auto-response or auto-deny settings for certain types of queries and/or certain sending users.

Alternatively, the first device 110 may be operable to track user's context pertinent responses and update one or more databases (maintained by, for example, the first device 110 and/or the NLU 106) for future context pertinent responses. In addition, the first device 110 and/or the NLU 106 may be operable to obtain context pertinent responses to communications via standard or common responses adapted or selected from a canonical set of context pertinent responses. It may be appreciated that such responses could be stored locally by the first device 110 or in an information depository “cloud.”

In this regard, the system architecture 100 may be operable to enable users to selectively identify all or a portion of contacts, in a contact list, for which certain status updates are visible or returnable in a context pertinent response to a received query communication. Such queries could include status queries (e.g., “where are you now?”), as well as historic information (e.g., identity of past locations at which the user has recently visited, future locations where the user intends to go). The granularity of the set of responsive information can be controllable by the user 108 and may include responsive answers, such as “busy/not-busy” and/or more detailed information.

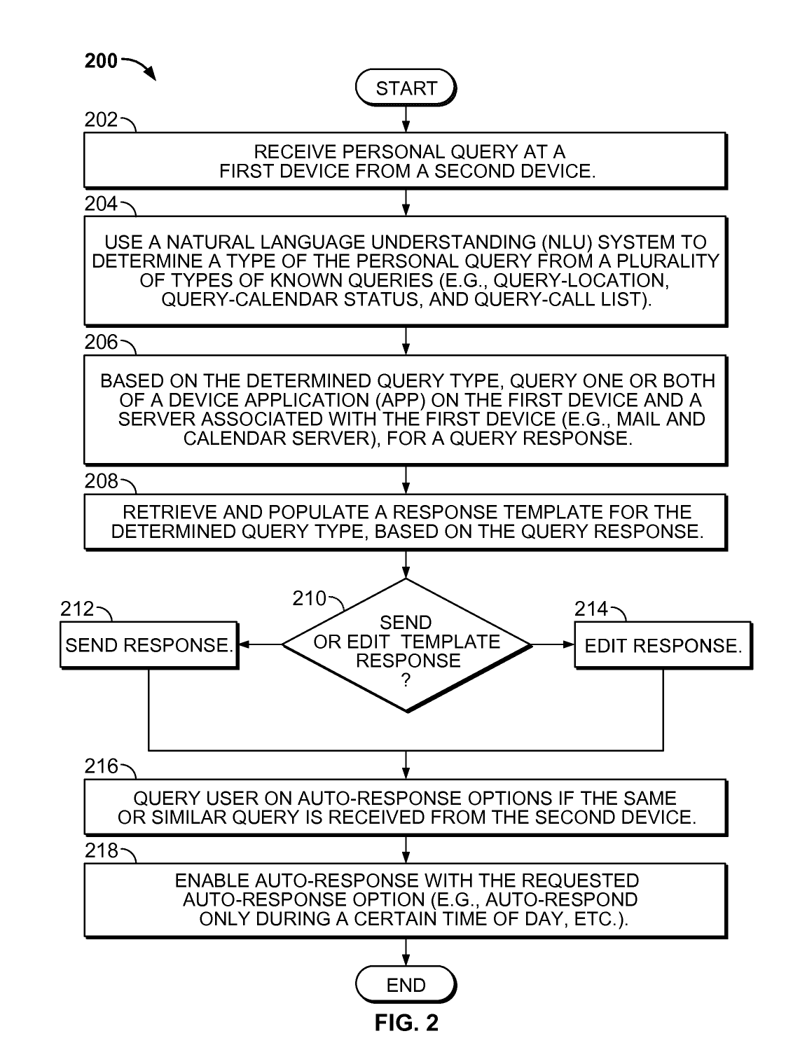

FIG. 2 is a flow chart illustrating example steps of a method for providing context pertinent responses, in accordance with an embodiment of the disclosure. Referring to FIGS. 1-2, the example method 200 may start at 202, when a personal query 114 may be received at the first device 110 from the second device 104. At 204, the NLU module 106 may determine a type of the personal query 114 from a plurality of types of known queries (e.g., Query-Location, Query-Calendar Status, and Query-Call List). Query-Location may be associated with queries that are related to current or future location of the receiving user (e.g., user 108). Query-Calendar Status may be associated with queries that are related to the receiving user's schedule (e.g., free or busy at a certain time, etc.). Query-Call List may be associated with queries that are related to whether or not the receiving user has called a certain phone number.

At 206, one or both of a device application (app) on the first device 110 and a server associated with the first device (e.g., mail and calendar server), may be queried for a query response, based on the determined query type. At 208, the first device 110 may retrieve and populate a response template 118 for a query response, based on the determined query type. Such template may be maintained by the device 110 or the NLU module 106. At 210, it may be determined whether to send or edit the populated response template 118.

If the user 108 decides to send the response, at 212, the response stated in the response template 118 may be sent to the first device 104. Alternatively, the user 108 may edit the response at 214. At 216, the user 108 may be queried regarding auto-response options, if the same or similar query is received from the second device 104. At 218, auto-response may be enabled with the requested auto-response option (e.g., auto-respond only during a certain time of day, etc.). The auto-response option may be enabled for all sending users, for certain sending users, and/or for certain types of messages (e.g., for queries of certain type).

FIG. 3 is a block diagram illustrating example architecture for providing context pertinent responses with online learning of privacy norms, in accordance with an embodiment of the disclosure. Referring to FIG. 3, the example architecture 300 may be similar to the system architecture 100 of FIG. 1 and may comprise the first (receiving) device 110 with a receiving user 108, the second (sending) device 104 with a sending user 102, and the natural language understanding (NLU) module 106. The system architecture 300 may also comprise an on-line learning (OLL) module 302.

The OLL module 302 may comprise suitable circuitry, logic and/or code and may be operable to store privacy profiles (e.g., profile 304) associated with one or more users (e.g., users profiled in a contact list stored by device 110). The privacy profiles may specify the query sender (contact) name, user group the sender is associated with, time of day when the privacy profile is active, query type (e.g., the type of queries the profile actions apply to), and response action (e.g., specifies what action may be automatically taken, if any, if a query from the sender is received).

Additionally, the OLL module 302 may communicate a probability of response value 308 to the first device 108 after the query interpretation 116 is generated by the NLU module 106. The probability of response value may range, for example, from 0 to 1. A value of 0 may indicate to the first device 110 that a response is not recommended. A value of 1 may indicate to the first device that an auto-response is recommended. A value of 0.5 may indicate that the first device 110 may first present the query interpretation 116 to the user 108 prior to sending a query response to user 102. The probability of response values 308 may be calculated based on privacy profiles (e.g., profile 304) of senders, as well as historic query response data based on responses provided by user 108 to received queries.

Even though the OLL module 302 and the NLU module 106 are shown as separate modules, the present disclosure may not be limited in this regard, and the two modules may be co-located in (or implemented as) a single module. For example, the OLL module 302 may be implemented as a part of the NLU 106. In the alternative, the NLU module 106 and/or the OLL module 302 may be implemented within the first device 110.

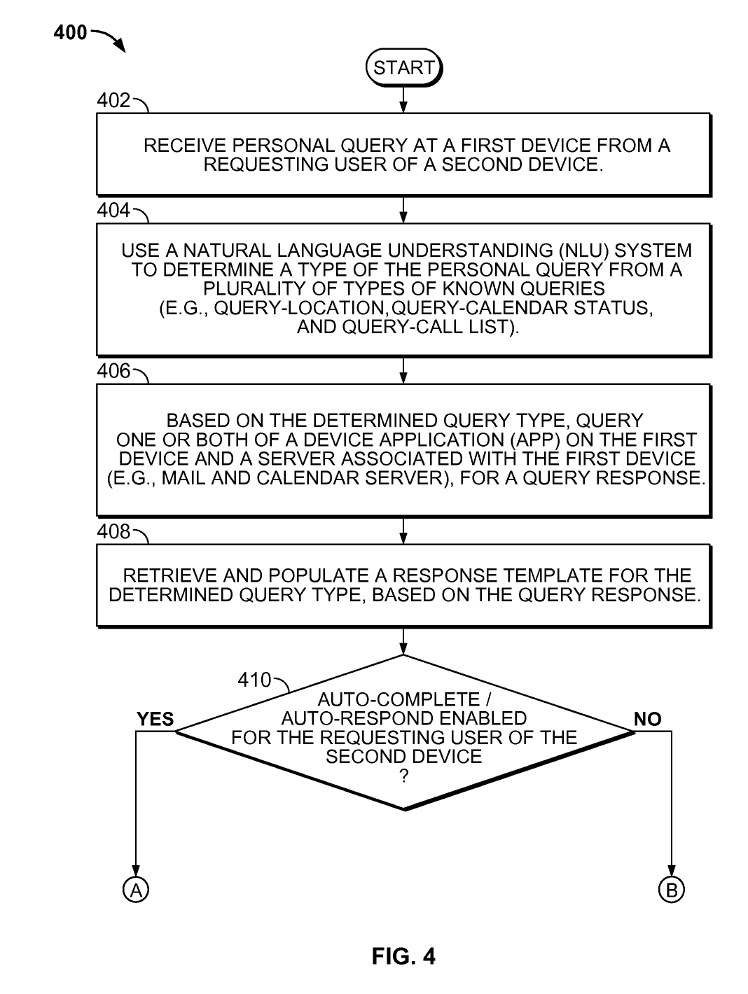

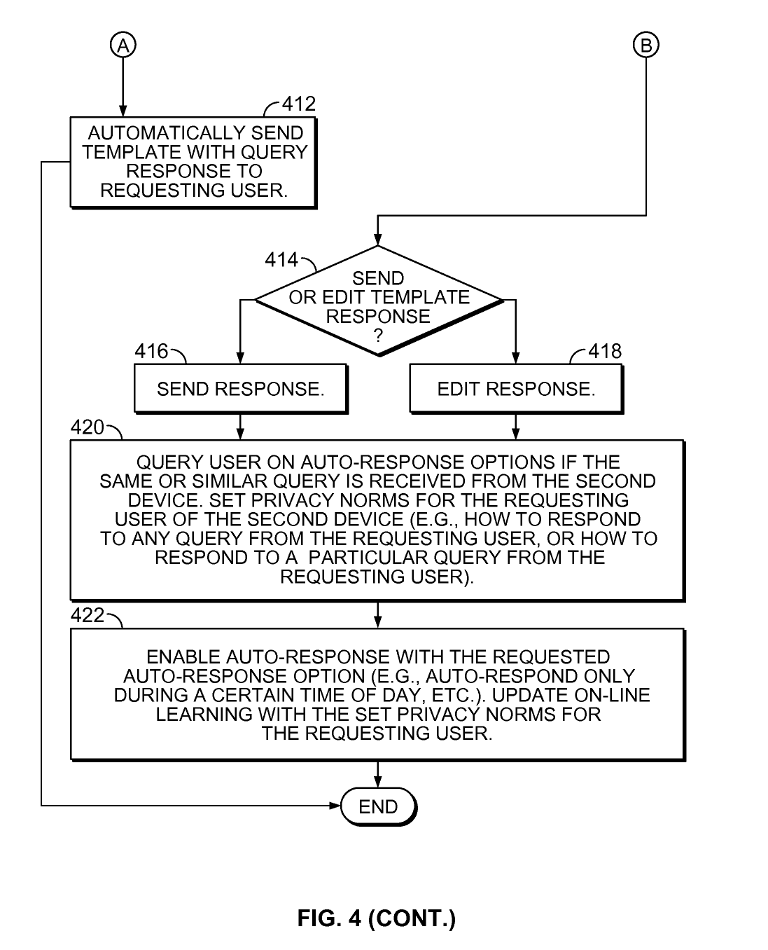

FIG. 4 is a flow chart illustrating example steps of a method for providing context pertinent responses with online learning of privacy norms, in accordance with an embodiment of the disclosure. Referring to FIGS. 3-4, the example method 400 may start at 402, when a personal query 114 may be received at the first device 110 from the second device 104. At 404, the NLU module 106 may determine a type of the personal query 114 from a plurality of types of known queries (e.g., Query-Location, Query-Calendar Status, and Query-Call List). Query-Location may be associated with queries that are related to current or future location of the receiving user (e.g., user 108). Query-Calendar Status may be associated with queries that are related to the receiving user's schedule (e.g., free or busy at a certain time, etc.). Query-Call List may be associated with queries that are related to whether or not the receiving user has called a certain phone number. In this instance, the query 114 (“Are you free? Dad”) is a Query-Calendar type of query (as seen in the query interpretation 116).

At 406, one or both of a device application (app) on the first device 110 and a server associated with the first device (e.g., mail and calendar server), may be queried for a query response, based on the determined query type. At 408, the first device 110 may retrieve and populate a response template 118 for a query response, based on the determined query type. Such template may be maintained by the device 110 or the NLU module 106.

At 410, it may be determined whether auto-complete (of a response template) and/or auto-response is enabled for the sending user 102 of the second device 104. For example, a privacy profile for user 102 may be stored by the OLL module 302, and the profile may b used to indicate whether or not auto-complete and/or auto-respond are enabled for user 102. If such privacy settings are enabled, at 412, the response in the response template 118 may be automatically sent to the user 102.

If auto-complete/auto-respond is not enabled for user 102 sending query 114, at 414, it may be determined whether to send or edit the populated response template 118.

If the user 108 decides to send the response, at 416, the response stated in the response template 118 may be sent to the first device 104. Alternatively, the user 108 may edit the response at 418. At 420, user 108 may be queried on auto-response options if the same or similar query is received from the second device 104 (i.e., from the sending user 102). The first device 110 may then set privacy norms for the requesting user 102 of the second device 104 (e.g., how to respond to any query from the requesting user 102 in the future, or how to respond to a particular query from the requesting user 102).

At 422, auto-response with the requested auto-response option may be enabled (e.g., auto-respond only during a certain time of day, etc.). In this regard, the first device 110 may update the privacy profile 304 stored by the OLL module 302 (on-line learning module 302 is updated with the set privacy norms for the sending user 102) (illustrated as 306 in FIG. 3).

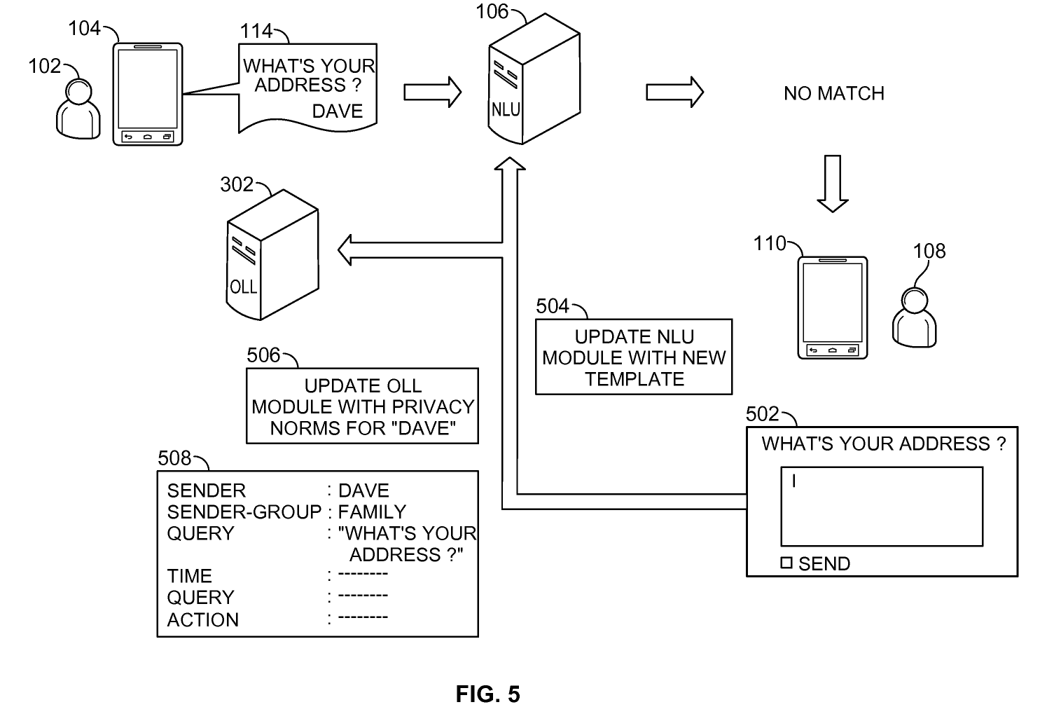

FIG. 5 is a block diagram illustrating example architecture for providing query responses and learning new query-related actions from user input, in accordance with an embodiment of the disclosure. Referring to FIG. 5, there is illustrated the system architecture 300 of FIG. 3. However, after the NLU module 106 receives the user query 114, the NLU module 106 may not locate a match for a previously saved template and may not be able to recognize the query type.

In this instance, the first device 110 may display a blank template 502, with the received query 114 posted in the template (e.g., “What's your address? Dave”). Upon entering the answer, user 108 may send the response to the user 102. Additionally, the first device 110 may perform template update 504 and may store the newly completed template with the answer from user 108 into the NLU module 106. The first device 108 may also present the user 108 with a privacy profile 508 for the sending user 102 (e.g., “Dave”). Upon completion of the privacy profile 508, an update 506 of privacy profiles may be performed and the newly completed profile 508 may be stored within the OLL module 302.

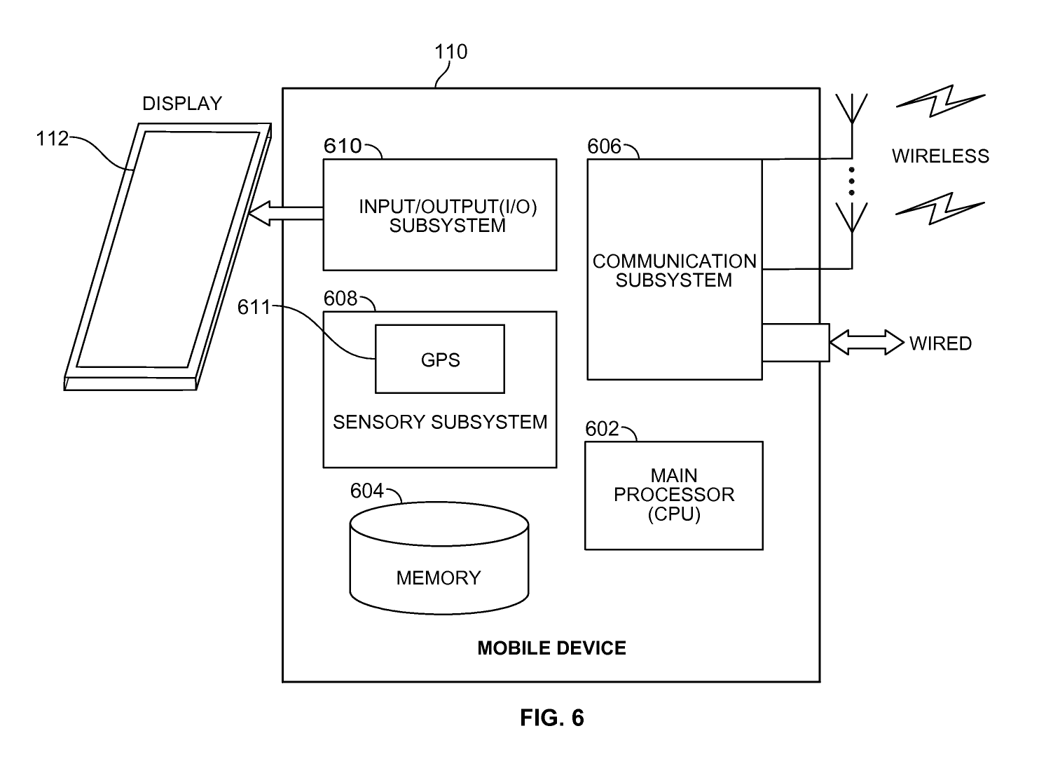

FIG. 6 is a block diagram of an example mobile device used for providing context pertinent responses, in accordance with an example embodiment of the disclosure. Referring to FIG. 6, the first device 110 may be a mobile device and may comprise suitable logic, circuitry, interfaces, and/or code that may be operable to implement various aspects of the above described architectures of FIGS. 1-5. The mobile device 110 may comprise, for example, a main processor 602, a system memory 604, a communication subsystem 606, a sensory and input/output (I/O) subsystem 608, an input/output (I/O) subsystem 610, and a display 112.

The main processor 602 may comprise suitable logic, circuitry, interfaces, and/or code that may be operable to process data, and/or control and/or manage operations of the mobile device 110, and/or tasks and/or applications performed therein in connection with providing automated response to personal queries, with optional machine learning to establish privacy norms. In this regard, the main processor 602 may be operable to configure and/or control operations of various components and/or subsystems of the mobile device 110, by utilizing, for example, one or more control signals. The main processor 602 enables running and/or execution of applications, programs and/or code (e.g., the program functionalities described in the claims as well as functionalities described herein above in reference to FIGS. 1-5), which may be stored, for example, in the system memory 604. Alternatively, one or more dedicated application processors may be utilized for running and/or executing applications (or programs) in the mobile device 110.

In some instances, one or more of the applications running and/or executing on the mobile device 110 may generate and/or update video content that may be rendered via the display 112. In other instances, one or more of the applications running and/or executing on the mobile device 110 may be used to perform functionalities explained herein in reference to the architectures of FIGS. 1, 3 and 5.

The system memory 604 may comprise suitable logic, circuitry, interfaces, and/or code that may enable permanent and/or non-permanent storage, buffering, and/or fetching of data, code and/or other information (e.g., query response templates and/or privacy profiles specifying privacy norms when communicating with users), which may be used, consumed, and/or processed. In this regard, the system memory 604 may comprise different memory technologies, including, for example, read-only memory (ROM), random access memory (RAM), Flash memory, solid-state drive (SSD), and/or field-programmable gate array (FPGA). The system memory 604 may store, for example, configuration data, which may comprise parameters and/or code, comprising software and/or firmware.

The communication subsystem 606 may comprise suitable logic, circuitry, interfaces, and/or code operable to communicate data from and/or to the mobile device, such as via one or more wired and/or wireless connections. The communication subsystem 606 may be configured to support one or more wired protocols (e.g., Ethernet standards, MOCA, etc.) and/or wireless protocols or interfaces (e.g., Bluetooth, WiFi, cellular, WiMAX, and/or any other available wireless protocol/interface), facilitating transmission and/or reception of signals to and/or from the mobile device 110, and/or processing of transmitted or received signals in accordance with applicable wired or wireless protocols. In this regard, signal processing operations may comprise filtering, amplification, analog-to-digital conversion and/or digital-to-analog conversion, up-conversion/down-conversion of baseband signals, encoding/decoding, encryption/decryption, and/or modulation/demodulation. In accordance with an embodiment of the disclosure, the communication subsystem 606 may provide wired and/or wireless connections to, for example, the first device 104, the NLU 106 and/or the OLL 302.

The sensory subsystem 608 may comprise suitable logic, circuitry, interfaces, and/or code for obtaining and/or generating sensory information, which may relate to the mobile device 110, its user(s), and/or its environment. For example, the sensory and I/O subsystem 608 may comprise positional or locational sensors (e.g., GPS or other GNSS based sensors 611), ambient conditions (e.g., temperature, humidity, or light) sensors, and/or motion related sensors (e.g., accelerometer, gyroscope, pedometers, and/or altimeters).

The I/O subsystem 610 may comprise suitable logic, circuitry, interfaces, and/or code for enabling user interactions with the mobile device 110, enabling obtaining input from user(s) and/or to providing output to the user(s). The I/O subsystem 610 may support various types of inputs and/or outputs, including, for example, video, audio, and/or textual. In this regard, dedicated I/O devices and/or components, external to or integrated within the mobile device 110, may be utilized for inputting and/or outputting data during operations of the I/O subsystem 610. Example I/O devices may comprise displays, mice, keyboards, touchscreens, voice input interfaces, and other input/output interfaces or devices. With respect to video outputs, the I/O subsystem 610 may be operable to generate and/or process video content, graphics, and/or textual data, and/or generate video frames based thereon for display, via the display 112 for example.

The display 112 may comprise suitable logic, circuitry, interfaces and/or code that may enable displaying of video content (e.g., response templates), which may be handled and/or processed via the I/O subsystem 610. The display 112 may be used in outputting video data, which may comprise contacts lists, response templates, and privacy profiles, as explained herein above.

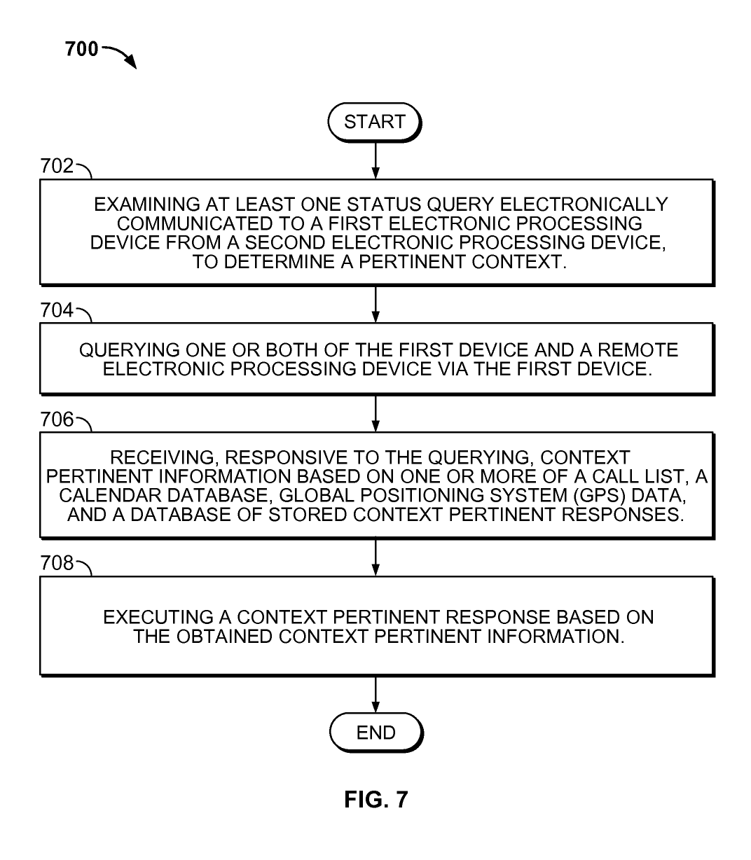

FIG. 7 is a flow chart illustrating example steps of another method for providing context pertinent responses, in accordance with an embodiment of the disclosure. Referring to FIGS. 1-7, the example method 700 may start at 702, at least one status query (e.g., 114) electronically communicated to a first electronic processing device (e.g., 110) from a second electronic processing device (e.g., 104), may be examined (e.g., by the NLU 106 and/or device 110) to determine a pertinent context. At 704, one or both of the first device (110) and a remote electronic processing device (e.g., the NLU 106 or a mail/calendar server associated with the first device 110) may be queried via the first device. At 706, responsive to the querying, context pertinent information may be received (e.g., by the first device 110) based on one or more of a call list, a calendar database, global positioning system (GPS) data, and a database of stored context pertinent responses. At 708, a context pertinent response based on the obtained context pertinent information may be executed.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for executing context pertinent responses.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A non-transitory, machine-readable storage medium, having stored thereon a computer program having at least one code section, the at least one code section executable by a first electronic processing device for causing the first electronic processing device to execute context pertinent responses based on at least one status query electronically communicated to the first electronic processing device from a second electronic processing device, wherein the at least one code section controls the first device to perform the steps of:
examining the query to determine a pertinent context;
querying a query processing device via the first device;
receiving, responsive to the querying, context pertinent information based on at least one database of stored context pertinent information; and
executing a context pertinent response based on the obtained context pertinent information.

2. The program of claim 1, wherein the first device is a mobile device, the status query concerns a current, prior or future location of the first device, the at least one database of stored context pertinent responses comprises global positioning system (GPS) data, and the response execution step includes the steps of:
analyzing the GPS data for the mobile device;
preparing a context pertinent text response including information obtained from the GPS data; and
electronically transmitting the prepared text response to the second device so as to complete a context pertinent communication exchange, wherein the query processing device is one or both of the mobile device and a remote electronic processing device.

3. The program of claim 1, wherein the first device is a mobile or stationary device, the status query concerns a current, prior or future location, the at least one database of stored context pertinent information comprises a calendar database, and the response execution step includes the steps of:
analyzing the calendar database to obtain schedule data associated with the current, prior or future location;
preparing a text response including information obtained from the calendar database; and
electronically transmitting the prepared text response to the second device content so as to complete a context pertinent communication exchange.

4. The program of claim 3, wherein the response execution step includes the step of:
analyzing GPS data for the mobile device to confirm a location coordinating with a location associated with the schedule data before preparing the text response, and including information obtained from the GPS data in the prepared response.

5. The program of claim 1, wherein the first device is a mobile device, the status query concerns the prior occurrence of a call, the at least one database of stored context pertinent information comprises a call list, and the execution step includes the steps of:
analyzing the call list for the mobile device to determine whether the call occurred; and
if the call did not occur, scheduling an electronic task reminder to place the call.

6. The program of claim 5, wherein the response execution step includes the steps of:
preparing a text response including information relating to time of the scheduled reminder for the call; and
electronically transmitting the prepared text response to the second device so as to complete a context pertinent communication exchange.

7. The program of claim 2, wherein the query is whether the current location is aboard a mass transportation implement, and the response execution step includes the steps of:
obtaining a schedule and a transportation route for the mass transportation implement by electronically communicating with a website or a database containing such schedule;
comparing the schedule and the transportation route with the GPS data;
based on the comparing, the step of preparing the context pertinent text response includes indicating whether or not the current location is aboard the mass transportation implement.

8. The program of claim 1, wherein the first device is a mobile device and the query is an estimated time of arrival, the at least one database of stored context pertinent information comprises GPS data, and the response execution step includes the steps of:
analyzing the GPS data including one or more of speed, direction and traffic conditions along an identified route associated with a user of the mobile device;
calculating a predicted estimated time of arrival;
preparing a text response including information obtained from the analyzing; and
electronically transmitting the prepared text response to the second device to complete a context pertinent communication exchange.

9. The program of claim 1, wherein the response execution step comprises:
preparing a context pertinent text response including information obtained from the obtaining step;
requesting authorization to transmit the proposed context pertinent text response to the second device;
upon receiving an authorization, transmitting the proposed context pertinent text response to the second device so as to complete a context pertinent communication exchange; or
upon receiving one or successive dissents, preparing one or successive alternative context pertinent text responses, including information obtained from the obtaining step, and requesting authorization to transmit the alternative responses, until authorization is received to transmit the response so as to complete an alternative context pertinent communication exchange; and
tracking the association of the request with the authorized responses and dissented responses for applications in future context pertinent communication exchanges.

10. The program of claim 9, where the first device is a mobile device and the authorization or dissents are received via a keypad, touch screen or via voice recognition technologies of the first device.

11. The program of claim 1, wherein the response execution step comprises:
preparing a context pertinent text response including information obtained from the obtaining step;
applying a context pertinent security level to the text based on information obtained from the obtaining step; and
electronically transmitting the prepared text response to the second device to complete a context pertinent communication exchange, where the transmission is provided with the context pertinent security level.

12. The program of claim 1, wherein the response execution step includes the steps of:
querying stored responses from previously executed context pertinent responses;
if a stored response is substantially applicable, then re-executing the stored response; and
if no stored response is substantially applicable, then executing a new context pertinent response based on the obtained context pertinent information.

13. A non-transitory, machine-readable storage medium, having stored thereon a computer program having at least one code section, the at least one code section executable by a first electronic processing device for causing the first electronic processing device to execute context pertinent responses based on at least one status query electronically communicated to the first electronic processing device from a second electronic processing device, wherein the at least one code section controls the first device to perform the steps of:
examining the query to determine a pertinent context;
querying a query processing device via the first device;
receiving, responsive to the querying, context pertinent information based on at least one source of context pertinent information;
determining an identity of a sending user of the second device sending the query; and
executing a context pertinent response based on the obtained context pertinent information and the identity of the sending user.

14. The program of claim 13, wherein the program controls the first device to perform the steps of:
determining whether the sending user is authorized by the first device to receive automatic responses to one or more queries; and
if the sending user is authorized, automatically executing the context pertinent response to complete a context pertinent communication exchange.

15. A method for executing context pertinent responses, comprising:
examining by a first electronic processing device, at least one status query electronically communicated to the first device from a second electronic processing device, to determine a pertinent context;
querying one or both of the first device and a remote electronic processing device via the first device;
receiving, responsive to the querying, context pertinent information based on at least one database of stored context pertinent information; and
executing a context pertinent response based on the obtained context pertinent information.

16. The method of claim 15, wherein the first device is a mobile device, the status query concerns a current, prior or future location of the first device, and the executing of the context pertinent response comprises:
analyzing the GPS data for the mobile device;
preparing a context pertinent text response including information obtained from the GPS data; and
electronically transmitting the prepared text response to the second device so as to complete a context pertinent communication exchange,
wherein the at least one database of stored context pertinent information comprises one or more of a call list, a calendar database, global positioning system (GPS) data, and a database of stored context pertinent responses.

17. The method of claim 15, wherein the first device is a mobile or stationary device, the status query concerns a current, prior or future location, the at least one database of stored context pertinent information comprises a calendar database, and the executing of the context pertinent response comprises:
analyzing the calendar database to obtain schedule data associated with the current, prior or future location;
preparing a text response including information obtained from the calendar database; and
electronically transmitting the prepared text response to the second device content so as to complete a context pertinent communication exchange.

18. The method of claim 17, comprising:
analyzing GPS data for the mobile device to confirm a location coordinating with a location associated with the schedule data before preparing the text response, and including information obtained from the GPS data in the prepared response.

19. The method of claim 15, wherein the first device is a mobile device, the status query concerns the prior occurrence of a call, the at least one database of stored context pertinent information comprises a call list, and the executing of the context pertinent response comprises:
analyzing the call list for the mobile device to determine whether the call occurred; and
if the call did not occur, scheduling an electronic task reminder to place the call.

20. The method of claim 19, comprising:
preparing a text response including information relating to time of the scheduled reminder for the call; and
electronically transmitting the prepared text response to the second device so as to complete a context pertinent communication exchange.
